(19) United States
(12) Patent Application Publication
(10) Pub. No.: US 2026/0259328 A1
(43) Pub. Date: Sep. 3, 2026

(54) METHOD AND APPARATUS FOR GLOBAL NAVIGATION SATELLITE SYSTEM MEASUREMENT REPORTING AND MEASUREMENT GAP CONFIGURATION

(71) Applicant: MediaTek Singapore Pte. Ltd., Singapore (SG)

(72) Inventors: Wen TANG, Beijing (CN); Yaohua CAI, Shanghai (CN)

(21) Appl. No.: 19/165,380

(22) PCT Filed: Mar. 20, 2024
(86) PCT No.: PCT/CN2024/082587

§ 371 Date: Sep. 15, 2025

(30) Foreign Application Priority Data
Apr. 12, 2023 (WO) PCT/CN2023/087865

(51) Int. Cl. G01S 19/03; H04W 64/00

(52) U.S. Cl. CPC G01S 19/03; H04W 64/00

(57) ABSTRACT

Various solutions for handling operations related to global navigation satellite system (GNSS) measurement reporting and measurement gap configuration are described. An apparatus may connect to a network node of a wireless network to operate in a connected state. The apparatus may also perform a GNSS measurement to obtain a valid GNSS position. The apparatus may further report a remaining GNSS validity duration to the network node responsive to an indication of obtaining the valid GNSS position.

### CROSS REFERENCE TO RELATED PATENT APPLICATION(S)

The present disclosure is part of a non-provisional application claiming the priority benefit of PCT Application No. PCT/CN2023/087865, filed 12 Apr. 2023, the content of which herein being incorporated by reference in its entirety.

### TECHNICAL FIELD

The present disclosure is generally related to mobile communications and, more particularly, to global navigation satellite system (GNSS) measurement reporting and measurement gap configuration.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, non-terrestrial network (NTN) is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite loT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

In scenarios with large transmission delay, such as the IoT NTN, to ensure normal system operation, the UE may need a valid GNSS position fix, which is used to determine the UE's location. For short sporadic data transmissions, the UE may acquire the GNSS position fix in radio resource control (RRC) idle state (also called RRC_IDLE mode). For large data transmissions in long connection time, the UE may need to perform GNSS measurement to re-acquire a valid GNSS position fix in RRC connected state (also called RRC_CONNECTED mode). However, in current 3GPP Release 18 standards, details of operations after the UE re-acquires a valid GNSS position fix in RRC_CONNECTED mode have not been fully discussed and some issues need to be solved. For example, some issues relate to how to report success of GNSS measurement and when to report new GNSS validity duration. Furthermore, another issue relates to how to configure GNSS measurement gap when the gap length is not provided by the network.

Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to GNSS measurement reporting and measurement gap configuration.

In one aspect, a method may involve an apparatus connecting to a network node of a wireless network to operate in a connected state. The method may also involve the apparatus performing a GNSS measurement to obtain a valid GNSS position. The method may further involve the apparatus reporting a remaining GNSS validity duration to the network node responsive to an indication of obtaining the valid GNSS position.

In one aspect, a method may involve a network node forming a serving cell for wireless communication with an apparatus operating in a connected state. The method may also involve the network node receiving a report of a remaining GNSS validity duration from the apparatus. The method may further involve the network node determining that a GNSS measurement is successful based on the report of the remaining GNSS validity duration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of GNSS measurement reporting in accordance with an implementation of the present disclosure.

FIG. 3 is a diagram depicting an example scenario of extension duration to GNSS validity duration in accordance with an implementation of the present disclosure.

FIG. 4 is a diagram depicting an example scenario of GNSS measurement gap configuration in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to GNSS measurement reporting and measurement gap configuration. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

In 3GPP Release 17, a UE in an loT NTN network needs to have a valid GNSS position fix before entering RRC_CONNECTED mode, and when the GNSS position fix becomes outdated, the UE enters RRC_IDLE mode. However, this design is not feasible for UE with potentially long uplink (UL) transmission and additional re-access to NTN network is needed, which is costing in terms of signaling overhead and delay. Depending on UE mobility, a UE in RRC_CONNECTED mode will need a new GNSS position fix to accommodate the accumulated time and frequency errors, such that the possibility of radio link failure may be reduced. As the 3GPP standards advance to Release 18, it is agreed that an loT NTN UE may need to re-acquire a valid GNSS position fix in long connection time. For GNSS position fix, hot start requires about 1~2 seconds, warm start requires several seconds, and cold start requires about 30 seconds.

Considering the problem of large transmission delay in an IoT NTN, details of operations after the UE re-acquires a valid GNSS position fix in RRC_CONNECTED mode have not been fully discussed in current 3GPP Release 18 standards, and issues regarding how to report success of GNSS measurement and when to report new GNSS validity duration remain unsolved. Furthermore, another issue regarding how to configure GNSS measurement gap when the gap length is not provided by the network also need to be solved. Accordingly, various proposed schemes in accordance with the present disclosure aim to provide techniques on GNSS measurement reporting and measurement gap configuration. Note that the present disclosure is motivated by, but not limited to, an IoT NTN scenario.

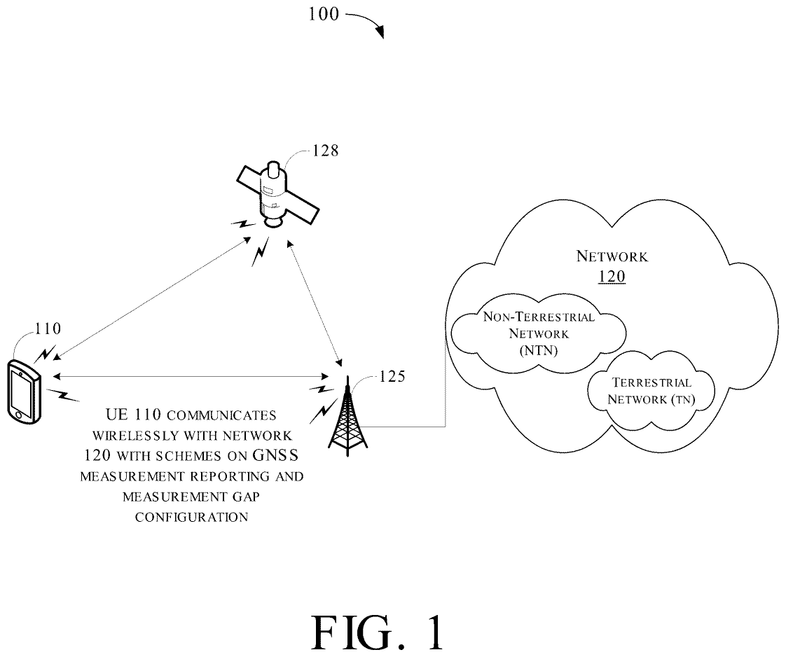

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form an NTN serving cell for wireless communication with the UE 110. In some implementations, the UE 110 may be an IoT device such as an NB-IoT UE or an eMTC UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to GNSS measurement reporting and measurement gap configuration in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In general, an loT system is mainly divided into NB-IoT and eMTC based on differences in system bandwidth and coverage. Typically, the bandwidth used in NB-IoT is about 200 kilo-hertz (KHz) and supports the transmission of low traffic data at a rate below 100 kilobits per second (Kbps). Conversely, eMTC technology typically utilizes 1.4 mega-hertz (MHz) bandwidth and the maximum data transmission rate is 1 megabits per second (Mbps).

Under a first proposed scheme in accordance with the present disclosure, for an loT UE (e.g., NB-IoT UE or BL/CE UE) that is connected to a wireless network (e.g., an NTN), if a GNSS measurement performed in the RRC_CONNECTED mode is successfully completed (before/after the original GNSS validity duration expires), the UE may report new GNSS validity duration to the wireless network to implicitly indicate success of the GNSS measurement in the RRC_CONNECTED mode. That is, for the loT UE operating in the RRC_CONNECTED mode, it may perform a GNSS measurement to obtain a valid GNSS position, and then report the remaining GNSS validity duration (i.e., the new GNSS validity duration) to a network node (e.g., the terrestrial network node 125 or the non-terrestrial network node 128) of the wireless network responsive to an indication of obtaining the valid GNSS position.

In some implementations, the reporting of the remaining GNSS validity duration may indicate that the GNSS measurement is successful.

In some implementations, the remaining GNSS validity duration may be reported via a medium access control (MAC) control element (CE) for GNSS validity duration reporting (e.g., a GNSS Duration Report MAC CE).

In some implementations, the UE may report the remaining GNSS validity duration with an UL grant for transmission (e.g., if the MAC entity has UL resources allocated for new transmission for this transmission time interval (TTI) and the UL resources can accommodate the GNSS Validity Duration Report MAC CE plus its subheader).

In some implementations, the UE may transmit a random access channel (RACH) with or without scheduling request (SR) for the report of the remaining GNSS validity duration. That is, the remaining GNSS validity duration may be reported through a random access (RA) procedure (e.g., if the MAC entity does not have UL resources allocated for new transmission for this TTI, or if the MAC entity has UL resources allocated for new transmission for this TTI but the UL resources cannot accommodate the GNSS Validity Duration Report MAC CE plus its subheader).

In some implementations, the original GNSS validity duration may correspond to the sum of the reported GNSS validity duration and an extension duration (e.g., a possible GNSS validity duration extension or a possible UL transmission extension), where the extension duration may be configured by network via an RRC message or a MAC CE. That is, the UE may receive a configuration of the extension duration from the network node, and determine that UL transmission is allowed in the extension duration subsequent to an expiry of the remaining GNSS validity duration. The configuration of the extension duration may be received via a MAC CE or an RRC message.

In some implementations, the extension duration may be set to the remaining time of a time alignment timer (or called timeAlignmentTimer). For example, the extension duration is equal to the remaining time of timeAlignment Timer if timeAlignment Timer is not set to infinity.

In some implementations, the configuration may include a value (denoted as Y) of the extension duration. For example, the extension duration is equal to Y if timeAlignment Timer is set to infinity.

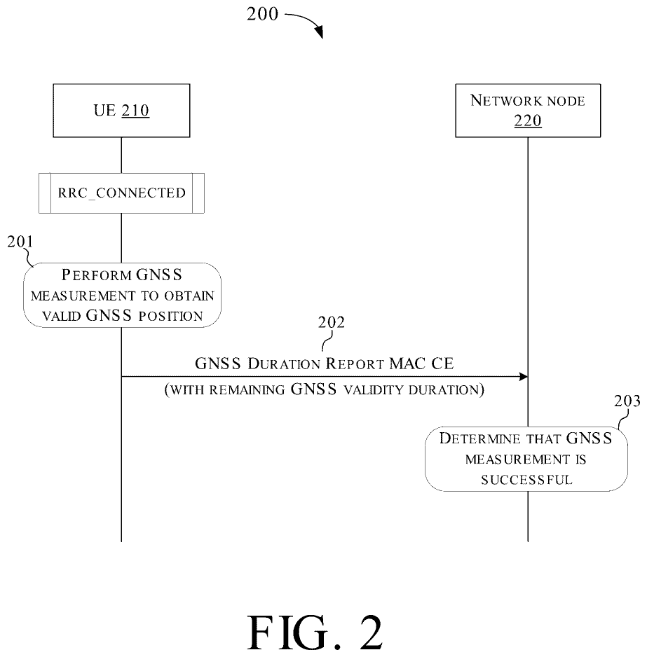

FIG. 2 illustrates an example scenario 200 of GNSS measurement reporting in accordance with an implementation of the present disclosure. As shown in FIG. 2, a UE 210 (e.g., an IoT UE) in RRC_CONNECTED mode wirelessly communicates with a network node 220 of a wireless network (e.g., an NTN) under the first proposed scheme on GNSS measurement reporting. At 201, the UE 210 performs a GNSS measurement to obtain a valid GNSS position. At 202, upon an indication that GNSS becomes valid (i.e., an indication of obtaining the valid GNSS position), the UE 210 transmits a GNSS Duration Report MAC CE to the network node 220 to report the remaining GNSS validity duration. Specifically, the GNSS Duration Report MAC CE implicitly indicates success of the GNSS measurement in the RRC_CONNECTED mode. At 203, upon receiving the GNSS Duration Report MAC CE with the remaining GNSS validity duration, the network node 220 knows/determines that a GNSS measurement is successfully completed by the UE 210.

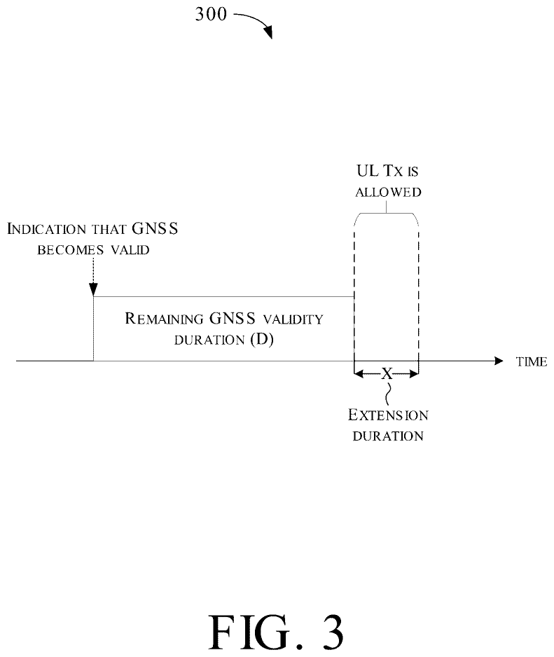

FIG. 3 illustrates an example scenario 300 of extension duration to GNSS validity duration in accordance with an implementation of the present disclosure. As shown in FIG. 3, the remaining GNSS validity duration (denoted as D) is determined upon an indication that GNSS becomes valid (i.e., indication of success of a GNSS measurement), wherein the remaining GNSS validity duration refers to the duration where the current GNSS position remains valid. The extension duration (denoted as X) is where UL transmission (Tx) can be allowed after the remaining GNSS validity duration expires without GNSS re-acquisition.

Under a second proposed scheme in accordance with the present disclosure, for network-triggered GNSS measurement, the UE may determine that the length of the GNSS measurement gap is equal to the latest reported GNSS position fix duration (or called gnss-PositionFixDuration, i.e., the time duration required for the UE to acquire a GNSS position fix) when the length of the GNSS measurement gap is not configured by the network node. That is, for an IoT UE (e.g., NB-IoT UE or BL/CE UE) that is connected to a wireless network (e.g., an NTN), it may report the time duration required for the UE to acquire/obtain a GNSS position fix to the network node, and then perform a GNSS measurement using a GNSS measurement gap with the reported time duration.

In some implementations, the UE may receive a MAC CE for triggering the GNSS measurement (e.g., called a GNSS Measurement Command MAC CE) from the network node. Specifically, the MAC CE for triggering the GNSS measurement does not indicate the length of the GNSS measurement gap (i.e., the GNSS measurement gap is not configured by the network).

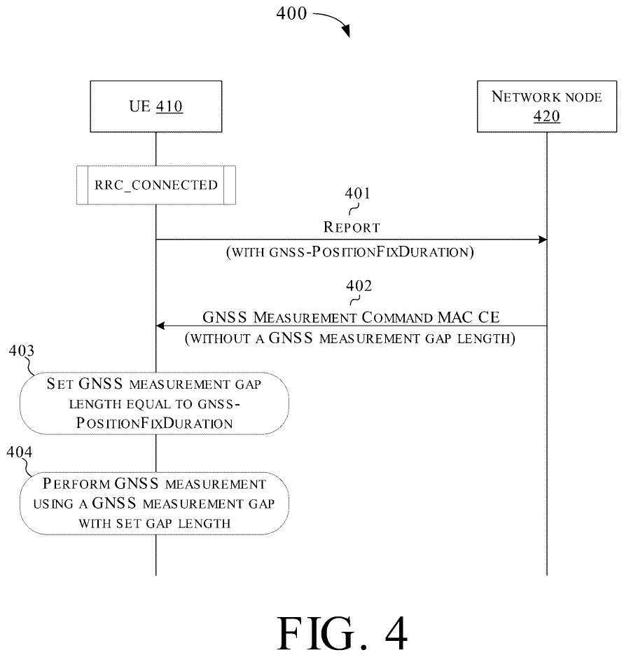

FIG. 4 illustrates an example scenario 400 of GNSS measurement gap configuration in accordance with an implementation of the present disclosure. As shown in FIG. 4, a UE 410 (e.g., an loT UE) in RRC_CONNECTED mode wirelessly communicates with a network node 420 of a wireless network (e.g., an NTN) under the second proposed scheme on GNSS measurement gap configuration. At 401, the UE 410 reports the time duration required for the UE to acquire a GNSS position fix (denoted as gnss-PositionFixDuration) to the network node 420. For example, the time duration may be reported via an RRC message (e.g., RRC connection setup complete). At 402, the UE 410 receives a GNSS Measurement Command MAC CE from the network node 420. Specifically, the GNSS Measurement Command MAC CE does not indicate the length of the GNSS measurement gap. At 403, the UE 410 sets the length of the GNSS measurement gap equal to the reported time duration (i.e., gnss-PositionFixDuration). At 404, the UE 410 performs a GNSS measurement using a GNSS measurement gap with the set gap length.

### Illustrative Implementations

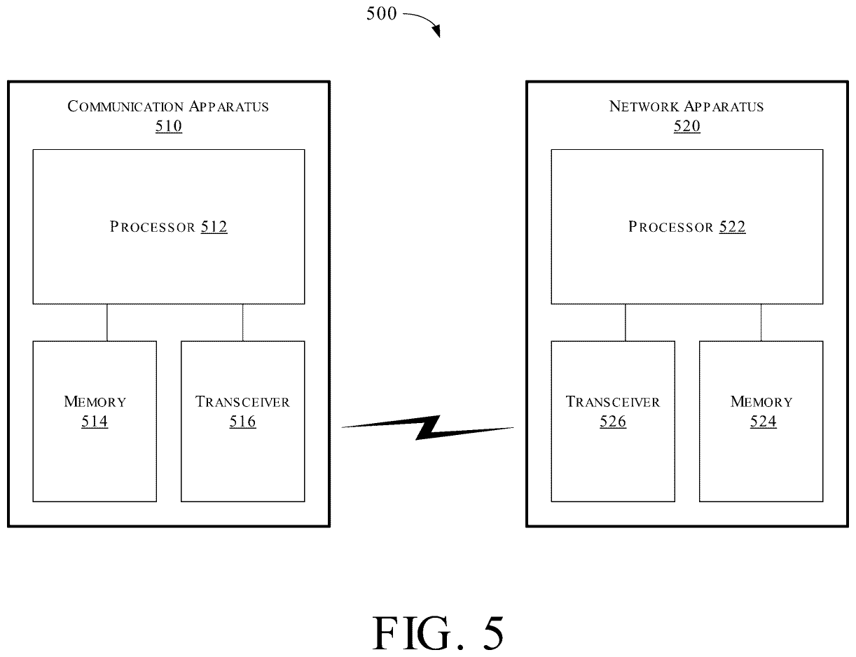

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to GNSS measurement reporting and measurement gap configuration, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a BS, a small cell, a router or a gateway of an NTN. For instance, network apparatus 520 may be implemented in a satellite or an eNB/gNB/TRP in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including GNSS measurement reporting and measurement gap configuration, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as an loT UE (e.g., an NB-IOT UE or a BL/CE UE), and network apparatus 520, as a network node (e.g., satellite or BS), is provided below.

Under certain proposed schemes in accordance with the present disclosure with respect to GNSS measurement reporting from UE's perspective, processor 512 of communication apparatus 510 may connect, via transceiver 516, to network apparatus 520 of a wireless network to operate in a connected state (e.g., RRC_CONNECTED mode). Then, processor 512 may perform, via transceiver 516, a GNSS measurement to obtain a valid GNSS position. Also, processor 512 may report, via transceiver 516, a remaining GNSS validity duration to network apparatus 520 responsive to an indication of obtaining the valid GNSS position.

In some implementations, the reporting of the remaining GNSS validity duration may indicate that the GNSS measurement is successful.

In some implementations, the remaining GNSS validity duration may be reported via a MAC CE for GNSS validity duration reporting (e.g., a GNSS Duration Report MAC CE).

In some implementations, the remaining GNSS validity duration may be reported using an UL grant for transmission.

In some implementations, the remaining GNSS validity duration may be reported through an RA procedure.

In some implementations, processor 512 may also receive, via transceiver 516, a configuration of an extension duration from network apparatus 520, and determine that UL transmission is allowed in the extension duration subsequent to an expiry of the remaining GNSS validity duration.

In some implementations, the configuration of the extension duration may be received via a MAC CE or an RRC message.

In some implementations, the extension duration may be set to a remaining time of a time alignment timer (e.g., a timeAlignmentTimer).

In some implementations, the configuration may include a value of the extension duration.

In some implementations, communication apparatus 510 may be an IoT UE (e.g., an NB-IoT UE or a BL/CE UE).

In some implementations, processor 512 may also report, via transceiver 516, a time duration required for communication apparatus 510 to obtain the GNSS position fix to network apparatus 520. Additionally, processor 512 may receive, via transceiver 516, a MAC CE for triggering the GNSS measurement from network apparatus 520. Specifically, the MAC CE does not indicate the length of the GNSS measurement gap, and the GNSS measurement is performed using a GNSS measurement gap with the time duration.

Under certain proposed schemes in accordance with the present disclosure with respect to GNSS measurement reporting from NW's perspective, processor 522 of network apparatus 520 may form, via transceiver 526, a serving cell for wireless communication with communication apparatus 510 operating in a connected state (e.g., RRC_CONNECTED mode). Then, processor 522 may receive, via transceiver 526, a report of a remaining GNSS validity duration from communication apparatus 510. Also, processor 522 may determine that a GNSS measurement by communication apparatus 510 is successful based on the report of the remaining GNSS validity duration.

In some implementations, the report of the remaining GNSS validity duration may be received via a MAC CE for GNSS validity duration reporting (e.g., a GNSS Duration Report MAC CE).

In some implementations, the report of the remaining GNSS validity duration may be received using an UL grant for transmission.

In some implementations, the report of the remaining GNSS validity duration may be received through an RA procedure.

In some implementations, processor 522 may also transmit, via transceiver 526, a configuration of an extension duration to communication apparatus 510. Specifically, the extension duration is where UL transmission is allowed subsequent to an expiry of the remaining GNSS validity duration.

In some implementations, the configuration of the extension duration may be transmitted via a MAC CE or an RRC message.

In some implementations, the configuration may include a value of the extension duration.

In some implementations, communication apparatus 510 may be an IoT UE (e.g., an NB-IoT UE or a BL/CE UE).

In some implementations, processor 522 may also receive, via transceiver 526, a report of a time duration required for communication apparatus 510 to obtain a GNSS position fix from communication apparatus 510. Additionally, processor 522 may transmit, via transceiver 526, a MAC CE for triggering the GNSS measurement to communication apparatus 510. Specifically, the MAC CE does not indicate the length of the GNSS measurement gap, and the GNSS measurement is performed using a GNSS measurement gap with the time duration.

### Illustrative Processes

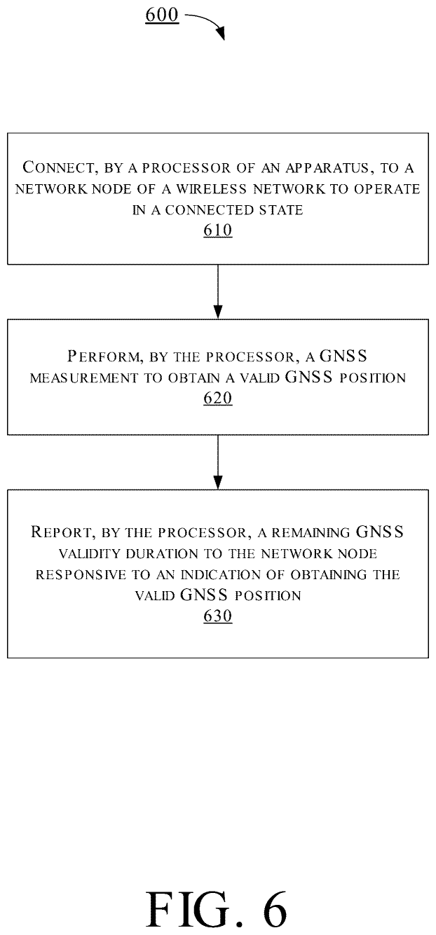

FIG. 6 illustrates an example process 600 in accordance with an implementation of the present disclosure. Process 600 may be an example implementation of above scenarios/schemes, whether partially or completely, with respect to GNSS measurement reporting. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of communication apparatus 510 connecting, via transceiver 516, to network apparatus 520 of a wireless network to operate in a connected state (e.g., RRC_CONNECTED mode). Process 600 may proceed from 610 to 620.

At 620, process 600 may involve processor 512 performing a GNSS measurement to obtain a valid GNSS position. Process 600 may proceed from 620 to 630.

At 630, process 600 may involve processor 512 reporting, via transceiver 516, a remaining GNSS validity duration to network apparatus 520 responsive to an indication of obtaining the valid GNSS position.

In some implementations, the reporting of the remaining GNSS validity duration may indicate that the GNSS measurement is successful.

In some implementations, the remaining GNSS validity duration may be reported via a MAC CE for GNSS validity duration reporting (e.g., a GNSS Duration Report MAC CE).

In some implementations, the remaining GNSS validity duration may be reported using an UL grant for transmission.

In some implementations, the remaining GNSS validity duration may be reported through an RA procedure.

In some implementations, process 600 may further involve processor 512 receiving, via transceiver 516, a configuration of an extension duration from network apparatus 520, and determining that UL transmission is allowed in the extension duration subsequent to an expiry of the remaining GNSS validity duration.

In some implementations, the configuration of the extension duration may be received via a MAC CE or an RRC message.

In some implementations, the extension duration may be set to a remaining time of a time alignment timer (e.g., a timeAlignmentTimer).

In some implementations, the configuration may include a value of the extension duration.

In some implementations, communication apparatus 510 may be an IoT UE (e.g., an NB-IoT UE or a BL/CE UE).

In some implementations, process 600 may further involve processor 512 reporting, via transceiver 516, a time duration required for communication apparatus 510 to obtain the GNSS position fix to network apparatus 520. Additionally, process 600 may involve processor 512 receiving, via transceiver 516, a MAC CE for triggering the GNSS measurement from network apparatus 520. Specifically, the MAC CE does not indicate the length of the GNSS measurement gap, and the GNSS measurement is performed using a GNSS measurement gap with the time duration.

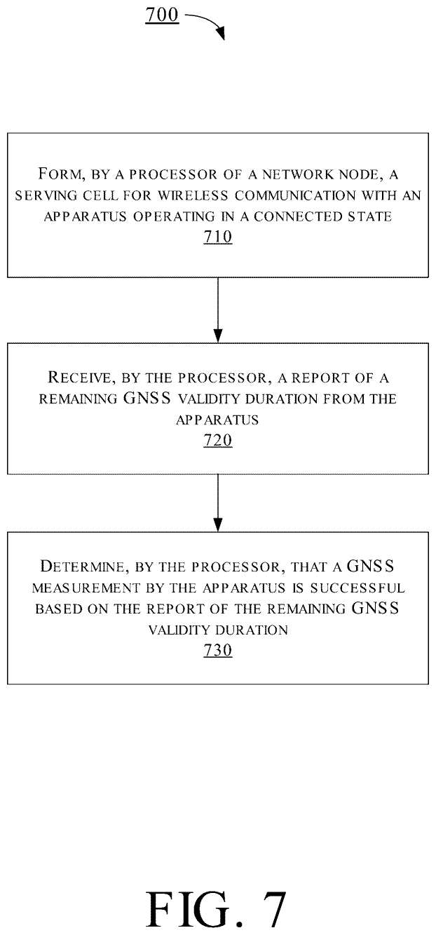

FIG. 7 illustrates an example process 700 in accordance with an implementation of the present disclosure. Process 700 may be an example implementation of above scenarios/schemes, whether partially or completely, with respect to GNSS measurement reporting. Process 700 may represent an aspect of implementation of features of network apparatus 520. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in network apparatus 520 as well as any variations thereof. Solely for illustrative purposes and without limitation, process 700 is described below in the context of network apparatus 520. Process 700 may begin at block 710.

At 710, process 700 may involve processor 522 of network apparatus 520 forming, via transceiver 526, a serving cell for wireless communication with communication apparatus 510 operating in a connected state (e.g., RRC_CONNECTED mode). Process 700 may proceed from 710 to 720.

At 720, process 700 may involve processor 522 receiving, via transceiver 526, a report of a remaining GNSS validity duration from communication apparatus 510. Process 700 may proceed from 720 to 730.

At 730, process 700 may involve processor 522 determining that a GNSS measurement by communication apparatus 510 is successful based on the report of the remaining GNSS validity duration.

In some implementations, the report of the remaining GNSS validity duration may be received via a MAC CE for GNSS validity duration reporting (e.g., a GNSS Duration Report MAC CE).

In some implementations, the report of the remaining GNSS validity duration may be received using an UL grant for transmission.

In some implementations, the report of the remaining GNSS validity duration may be received through an RA procedure.

In some implementations, process 700 may further involve processor 522 transmitting, via transceiver 526, a configuration of an extension duration to communication apparatus 510. Specifically, the extension duration is where UL transmission is allowed subsequent to an expiry of the remaining GNSS validity duration.

In some implementations, the configuration of the extension duration may be transmitted via a MAC CE or an RRC message.

In some implementations, the configuration may include a value of the extension duration.

In some implementations, communication apparatus 510 may be an IoT UE (e.g., an NB-IoT UE or a BL/CE UE).

In some implementations, process 700 may further involve processor 522 receiving, via transceiver 526, a report of a time duration required for communication apparatus 510 to obtain a GNSS position fix from communication apparatus 510. Additionally, process 700 may involve processor 522 transmitting, via transceiver 526, a MAC CE for triggering the GNSS measurement to communication apparatus 510. Specifically, the MAC CE does not indicate the length of the GNSS measurement gap, and the GNSS measurement is performed using a GNSS measurement gap with the time duration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of an apparatus, to a network node of a wireless network to operate in a connected state;
performing, by the processor, a global navigation satellite system (GNSS) measurement to obtain a valid GNSS position; and
reporting, by the processor, a remaining GNSS validity duration to the network node responsive to an indication of obtaining the valid GNSS position.

2. The method of claim 1, wherein the reporting of the remaining GNSS validity duration indicates that the GNSS measurement is successful.

3. The method of claim 1, wherein the remaining GNSS validity duration is reported via a medium access control (MAC) control element (CE) for GNSS validity duration reporting.

4. The method of claim 1, wherein the remaining GNSS validity duration is reported using an uplink (UL) grant for transmission.

5. The method of claim 1, wherein the remaining GNSS validity duration is reported through a random access (RA) procedure.

6. The method of claim 1, further comprising:
receiving, by the processor, a configuration of an extension duration from the network node; and
determining, by the processor, that UL transmission is allowed in the extension duration subsequent to an expiry of the remaining GNSS validity duration.

7. The method of claim 6, wherein the configuration of the extension duration is received via a MAC CE or a radio resource control (RRC) message.

8. The method of claim 6, wherein the extension duration is set to a remaining time of a time alignment timer.

9. The method of claim 6, wherein the configuration comprises a value of the extension duration.

10. The method of claim 1, wherein the apparatus is an Internet-of-things (IoT) user equipment (UE).

11. The method of claim 1, further comprising:
reporting, by the processor, a time duration required for the apparatus to obtain the GNSS position fix to the network node; and
receiving, by the processor, a MAC CE for triggering the GNSS measurement from the network node;
wherein the MAC CE does not indicate the length of the GNSS measurement gap, and the GNSS measurement is performed using a GNSS measurement gap with the time duration.

12. A method, comprising:
forming, by a processor of a network node, a serving cell for wireless communication with an apparatus operating in a connected state; and
receiving, by the processor, a report of a remaining global navigation satellite system (GNSS) validity duration from the apparatus; and
determining, by the processor, that a GNSS measurement by the apparatus is successful based on the report of the remaining GNSS validity duration.

13. The method of claim 12, wherein the report of the remaining GNSS validity duration is received via a medium access control (MAC) control element (CE) for GNSS validity duration reporting.

14. The method of claim 12, wherein the report of the remaining GNSS validity duration is received using an uplink (UL) grant for transmission.

15. The method of claim 12, wherein the report of the remaining GNSS validity duration is received through a random access (RA) procedure.

16. The method of claim 12, further comprising:
transmitting, by the processor, a configuration of an extension duration to the apparatus, wherein the extension duration is where UL transmission is allowed subsequent to an expiry of the remaining GNSS validity duration.

17. The method of claim 16, wherein the configuration of the extension duration is transmitted via a MAC CE or a radio resource control (RRC) message.

18. The method of claim 16, wherein the configuration comprises a value of the extension duration.

19. The method of claim 12, wherein the apparatus is an Internet-of-things (IoT) user equipment (UE).

20. The method of claim 12, further comprising:
receiving, by the processor, a report of a time duration required for the apparatus to obtain a global navigation satellite system (GNSS) position fix from the apparatus; and
transmitting, by the processor, a MAC CE for triggering the GNSS measurement to the apparatus;
wherein the MAC CE does not indicate the length of the GNSS measurement gap, and the GNSS measurement is performed using a GNSS measurement gap with the time duration.
